(19) United States
(12) Patent Application Publication
(10) Pub. No.: US 2009/0328190 A1
(43) Pub. Date: Dec. 31, 2009

(54) METHOD AND APPARATUS TO PERFORM SECURITY AND VULNERABILITY TESTING OF PROTOCOLS

(76) Inventors: David H. Liu, Herndon, VA (US); Shih-Chang Liang, Rockville, MD (US); Marc R. Bernard, Miramar, FL (US); Guy M. Merritt, Purcellville, VA (US); Fung-Chang Huang, Herndon, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/145,928

(22) Filed: Jun. 25, 2008

(51) Int. Cl. G06F 21/00

(52) U.S. Cl. 726/14

(57) ABSTRACT

Flaws in information security infest modern software, and pervasive computing has made network systems vulnerable. Information security is constantly endangered by errors in protocol implementations. Testing a protocol implementation for errors directly from a network where a device implementing the protocol resides limits the coverage of protocols tested. In contrast, testing protocols from an access network that internetworks a customer premises with one or more service networks greatly expands the coverage of protocols tested. Accordingly, a method and corresponding apparatus are provided to test from the access network, testing both service network devices and customer premises devices, and the protocols implemented on those devices.

### BACKGROUND OF THE INVENTION

Flaws in information security infest modern software, and pervasive computing has made network systems vulnerable. Information security is constantly endangered by errors in protocol implementations. Software vulnerability testing suites offer protocol and software vulnerability testing. Some are developed to systematically test implementations of protocols in a “black-box” fashion. These vulnerability testing suites test protocols using test messages. These test messages are repeatedly transmitted to a target to ensure that the target can sustain such a test or attack. If the target crashes or otherwise fails, the vulnerability is noted.

### SUMMARY OF THE INVENTION

Example embodiments of the present invention may be implemented in the form of a method or corresponding apparatus that tests protocols. A method and corresponding apparatus according to one embodiment of the present invention includes incorporating a mutation into a message of a protocol under test as a function of a key to produce a mutated message. The key is normally used to maintain a security state between nodes in an access network. To test the protocol under test, the mutated message produced is transmitted from the access network to a network external from the access network and accessed via the access network.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example access network, internetworking a customer premises with service networks in which example embodiments of the present invention may be deployed;

FIGS. 2A-2C are message diagrams of a message incorporating a mutation to produce a mutated message, in accordance with example embodiments of the present invention;

FIG. 2D and 2E are message diagrams of a mutated message transmitted from an access network, in accordance with example embodiments of the present invention;

FIG. 3 is a network diagram of a passive optical network (PON) as an access network in which example embodiments of the present invention may be deployed;

FIG. 4 is a series of printouts displaying a churning key used by an example embodiment of the present invention;

FIG. 5 is a flowchart of an example process for testing protocols, in accordance with an example embodiment of the present invention; and

FIG. 6 is a block diagram of an example apparatus to test protocols, in accordance with an example embodiment of the present invention.

### DETAILED DESCRIPTION OF THE INVENTION

A description of example embodiments of the invention follows.

A “fuzzing tool” or “fuzzer” uses the “fuzz testing” methodology of testing, which provides random valid data to the inputs of a program (or application) in an attempt to crash the program. This methodology of testing uses a “fuzz message” or a string of fuzz messages (also known as a “fuzz stream”) to test or otherwise attack a protocol under test. The fuzz message includes pseudo-random characters (or numbers) generated along with a valid data structure of a message of the protocol under test. Thus, a typical fuzz message has a valid data structure, but within the data structure of the fuzz message, there are pseudo-random characters (or numbers).

The pseudo-random characters (or numbers) may be inserted into a message of a protocol under test by:

1) event driven inputs from a mechanism in an embedded system;

2) character driven inputs from files or data streams such as sockets;

3) database inputs from tabular data, such as relational databases; or 4) inherited program state such as environmental variables.

During a test or attack, the fuzzer (i.e., the test device) takes a properly formatted message of a protocol under test and mutates the message by inserting pseudo-random characters (or numbers) into the message to produce a mutated message. After the mutated message is sent, the fuzzer generates another message with another pseudo-random characters (or numbers) hidden in the message. This process repeats over and over again until anomaly occurs in the target or device under test.

To initiate a vulnerability test, test equipment, such as a fuzzer, is connected to a network under test. From the test equipment, a target address of a device under test and a protocol under test are specified. To test some protocols, in particular connection-orientated or based protocols, a test starts with the test equipment simulating an endpoint and attempting to negotiate with the device under test. The device under test then responds and proceeds with a handshake process. During a test of such a protocol, the test equipment continues sending mutated messages. Because these mutated messages conform to the valid message structure of a message of the protocol under test, the device under test should continue to respond. However, failure to respond or other negative effect of the mutated message transmitted on the protocol under test indicates a potential security fault or vulnerability of the protocol under test.

Existing fuzzing tools test or otherwise attack a device under test or a protocol under test from a network where the device under test resides, for example, by directly connecting to an Ethernet port of the network. In contrast, embodiments of the present invention test from an access network, and thus, test devices and protocols that are accessed via the access network. For example, the access network provides access or otherwise connects to multiple service networks, such as a voice network, high speed Internet data network, or Internet protocol (IP) video network. As such, by testing from an access network, embodiments of the present invention test a multitude of devices and protocols, such as network servers and applications. In another example, the access network also connects to a customer premises. As such, by testing from the access network, embodiments of the present invention also test devices and protocols of the customer premises, such as customer premises equipment (CPE) connected to a local area network (LAN) side of a home or business. This is extremely useful for mission critical environments, such as government applications.

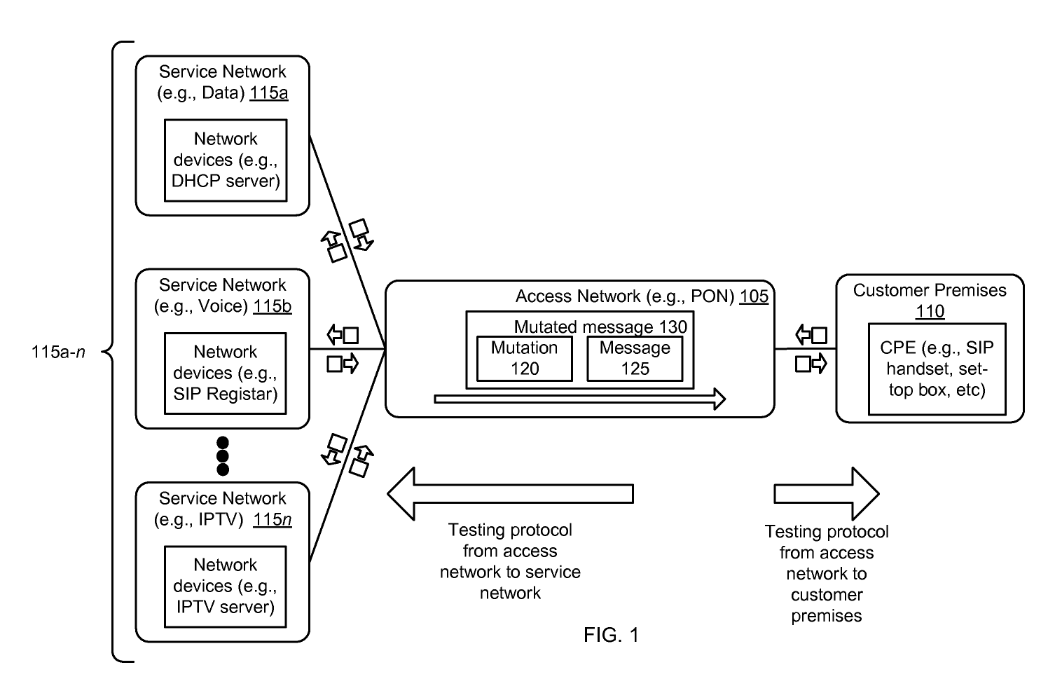

FIG. 1 illustrates an access network 105 providing a customer premises 110 access to one or more service networks 115a, 1115b . . . 115n, generally 115a-n, and the services provided, e.g., voice, video, and data. The service networks 115a-n are accessed via the access network 105 in the sense that messages are communicated to and from the service networks 115a-n through the access network 105. The same can be said of the customer premises 110 accessed via the access network 105.

FIG. 1 further illustrates a mutation 120 incorporated into or associated with (assumed throughout) a message 125 to produce a mutated message 130. Described later in greater detail, the mutation 120 is incorporated into the message 125 as a function of a key (not shown) normally used to implement a security state between nodes within the access network 105. For now, it is sufficient to note normally the meaning of the key is confined or otherwise limited to the access network 105. As such, the key is neither used outside of the access network 105 nor is the key exchanged with networks external from the access network 105, such as the customer premises 110 and the service networks 115a-n. The mutated message 130 is transmitted to a network external from the access network 105 and that is accessed via the access network 105, in this example, the customer premises 110 and service networks 115a-n. Embodiments of the present invention may be said to test protocols from an access network to a service network and from an access network to a customer premises.

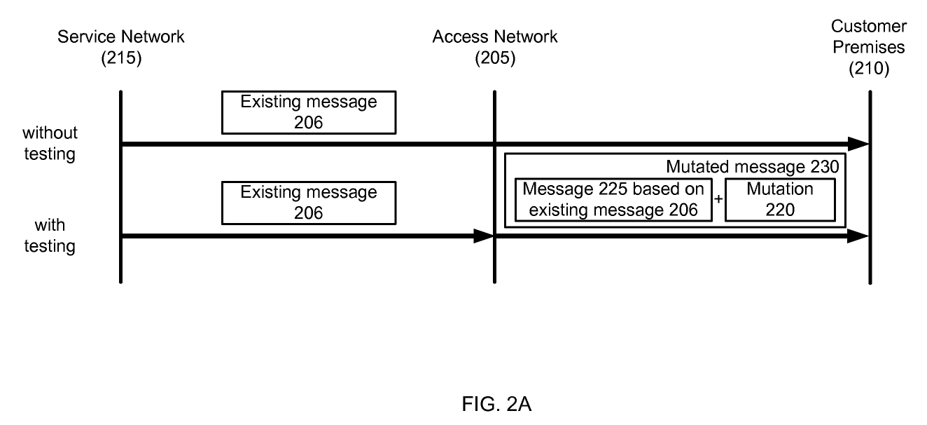

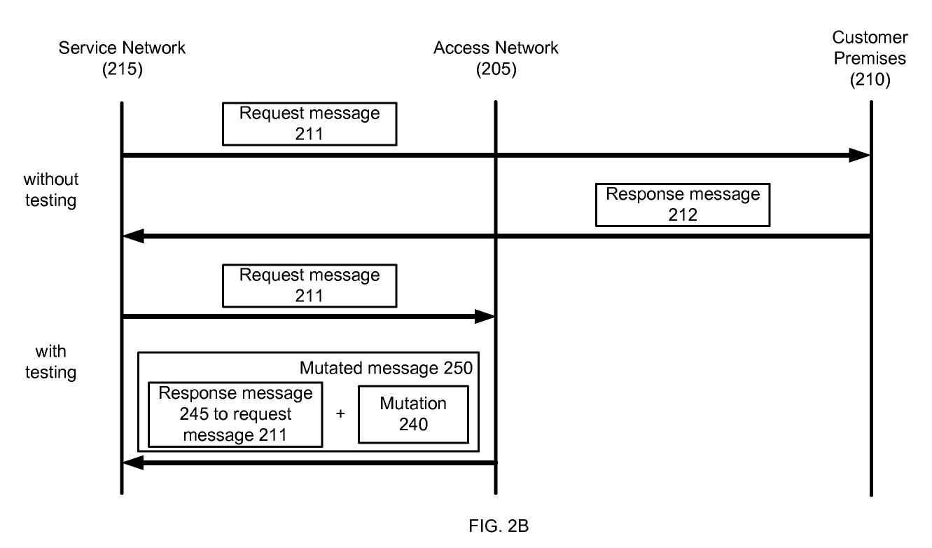

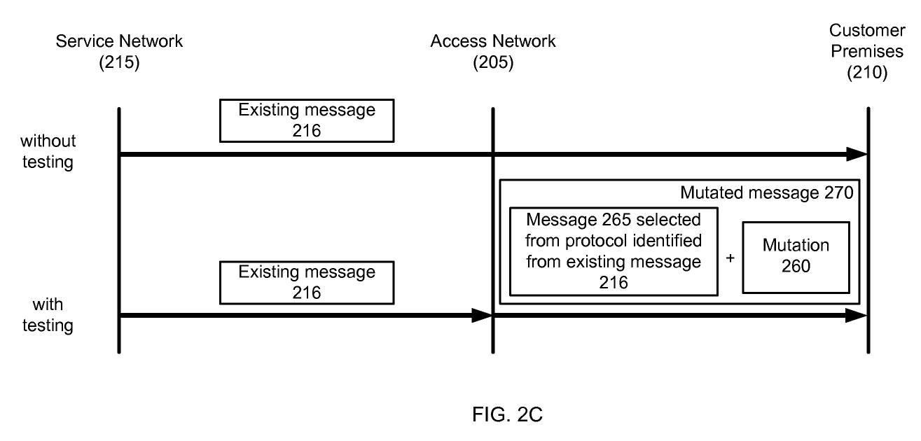

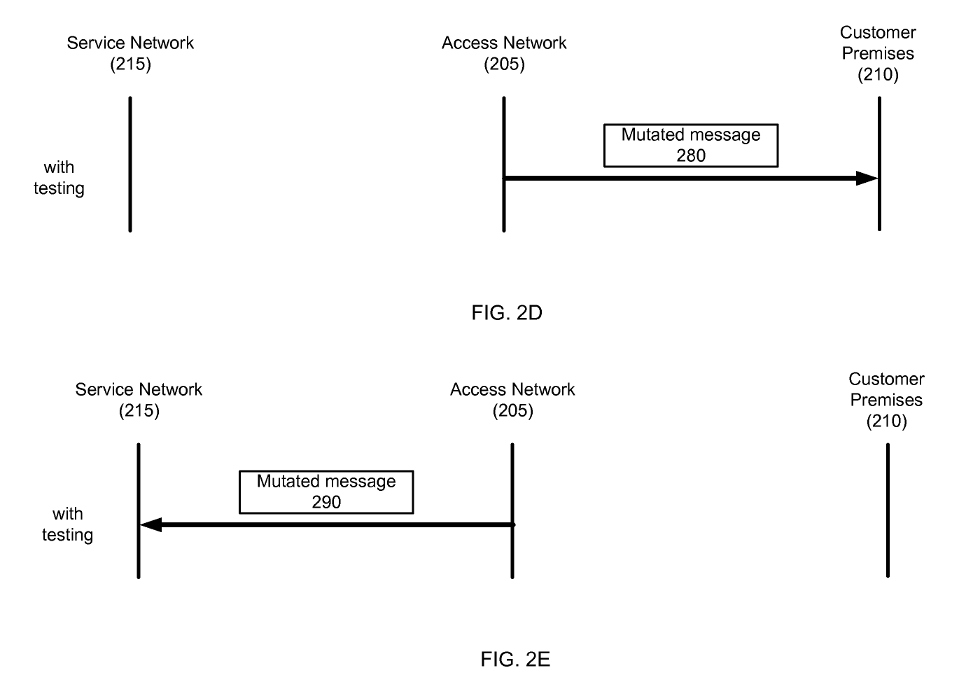

FIG. 2A illustrates, at reference label “without testing” via an access network 205, a message referred to in this example as an existing message 206, is communicated between a customer premises 210 and a service network 215 (illustrated as from the service network 215 to the customer premises 210). The existing message 206 represents a message from a connectionless-based protocol. A defining feature of a connectionless-based protocol is the lack of acknowledgement. In a connectionless-based protocol, receipt of a message is not acknowledged. A sender of a message of a connectionless-based protocol does not know whether the message is successfully received by a receiver or not. As such, an unsuccessful message is not re-delivered. Examples of a connectionless-based protocol include User Datagram Protocol (UDP) and applications using or otherwise relying on UDP transport, such as Real-time Transport Protocol (RTP).

At reference label “with testing,” one embodiment of the technique bases a message 225 into which a mutation 220 is incorporated on the existing message 206 to produce a mutated message 230. Accordingly, the embodiment illustrated in FIG. 2A may be for testing connectionless-based protocols.

FIG. 2B illustrates at reference label “without testing,” via the access network 205, a first message, referred to in this example as a request message 211, and a second message, referred to in this example as a response message 212, communicated between the customer premises 210 and the service network 215. The request message 211 and the response message 212 represent messages from a connection-based protocol. Acknowledging receipt of a message is a defining feature of a connection-based protocol. A sender of a message of a connection-based protocol knows whether the message is successfully received by a receiver or not. As such, an unsuccessful message is re-delivered. Examples of a connection-based protocol include Transmission Control Protocol (TCP) and applications using or otherwise relying on TCP transport, such as Hypertext Transfer Protocol (HTTP). the request message 211 communicated between the customer premises 210 and the service network 215 via the access network 205 with a response message 245, into which a mutation 240 is incorporated to produce a mutated message 250. Accordingly, the embodiment illustrated in FIG. 2B may be for testing connection-based protocols.

FIG. 2C illustrates at reference label “without testing,” via the access network 205, a message referred to in this example as an existing message 216, communicated between the customer premises 210 and the service network 215 (illustrated as from the service network 215 to the customer premises 210).

At reference label “with testing,” one embodiment of the technique identifies a protocol under test from the existing message 216 communicated between the customer premises 210 and the service network 215 via the access network 205. The embodiment then selects a message 265 of the protocol under test identified into which a mutation 260 is incorporated to produce a mutated message 270.

While the foregoing embodiments describe and illustrate basing a message into which a mutation is incorporated on an existing message, other embodiments transmit a mutated message from an access network without the need to base the mutated message on an existing message. For example, mutated messages may be provided by or otherwise retrieved from a file to test the protocol under test.

FIG. 2D illustrates an embodiment transmitting a mutated message 280 from the access network 205 to the customer premises 210 to test a protocol under test. The customer premises 210 is accessed via the access network 205.

FIG. 2E illustrates an embodiment transmitting a mutated message 290 from the access network 205 to the service network 215 to test a protocol under test. The service network 215 is accessed via the access network 205

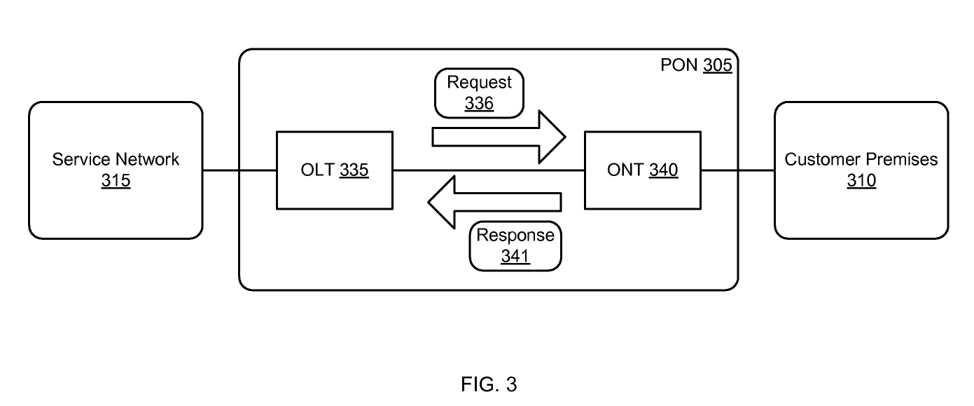

FIG. 3 illustrates an access network as a passive optical network (PON) 305 providing a customer premises 310 access to a service network 315 and the services provided (e.g., data). The PON 305 is a point-to-multipoint, fiber to the premises network architecture in which unpowered optical splitters (not shown) are used to enable a single optical fiber to serve multiple premises, such as the customer premises 310. The PON 305 consists of an Optical Line Terminal (OLT) 335, an Optical Network Terminal (ONT) 340 and other ONTs (not shown).

Upstream communications or signals from the ONT 340 to the OLT 335 are combined with upstream communications or signals from the other ONTs using a multiple access protocol, such as time division multiple access (TDMA). Downstream communications or signals from the OLT 335 are broadcast to both the ONT 340 and the other ONTs sharing the fiber. As such, all downstream receivers (i.e., the ONT 340 and the other ONTs) receive the downstream communications and discard those downstream communications not intended for them.

To prevent eavesdropping by the other ONTs, downstream communications from the OLT 335 to the ONT 340 are churned, or scrambled, using a churning key generated by the ONT 340. As such, it may be said that the churning key is a key used to maintain a security state between nodes in an access network, viz., the OLT 335 and the ONT 340 in the PON 305. A convenient embodiment of the present invention churns downstream user data cells with a churning key (also referred to as a churn key) in accordance with International Telecommunication Union (ITU) G.983.1, section 8.3.5.6, which defines generation of the churning key, notification of the churning key, churning function in an OLT, churning function in an ONT, and churning message flow.

Continuing with FIG. 3, the OLT 335 requests (336) a churning key from the ONT 340. The ONT 340 responds (341) with the churning key.

The OLT 335 churns downstream user data cells with the churning key. The ONT de-churns the user data cells received with the churning key. Without the appropriate churning key, churned user data cells cannot be successfully de-churned, thus securing receipt of the user data cells by an appropriate ONT and not another. As such, the churning key is normally used to maintain a security state of downstream cells from an OLT to an ONT.

In contrast, an example embodiment of the present invention uses a churning key for testing a protocol by incorporating a portion or a repetition of the churning key into a message of a protocol under test to produce a mutated message. The embodiment then tests the protocol under test with the mutated message.

As described previously, the fuzz testing methodology of testing uses a “fuzz message” or a string of fuzz messages (also known as a “fuzz stream”) to test or otherwise attack a protocol under test. The fuzz message is pseudo-random characters (or numbers) generated along with a valid data structure of a message of the protocol under test. Thus, a typical fuzz message has a valid data structure, but within the data structure of the fuzz message, there are pseudo-random characters (or numbers).

For a valid message to mutate, the embodiment uses a valid message format of a message of a protocol under test and inserts or otherwise incorporates randomly generated characters inside the message to test the protocol under test. For this, the embodiment uses the randomly generated churning key. The churning key is a randomly generated key used for encryption and security purposes as described above. Every second, an ONT generates a unique churning key. To mutate a message of a protocol under test, the embodiment inserts or otherwise incorporates the churning key into a valid message, the location in which to insert may be specified in a further embodiment.

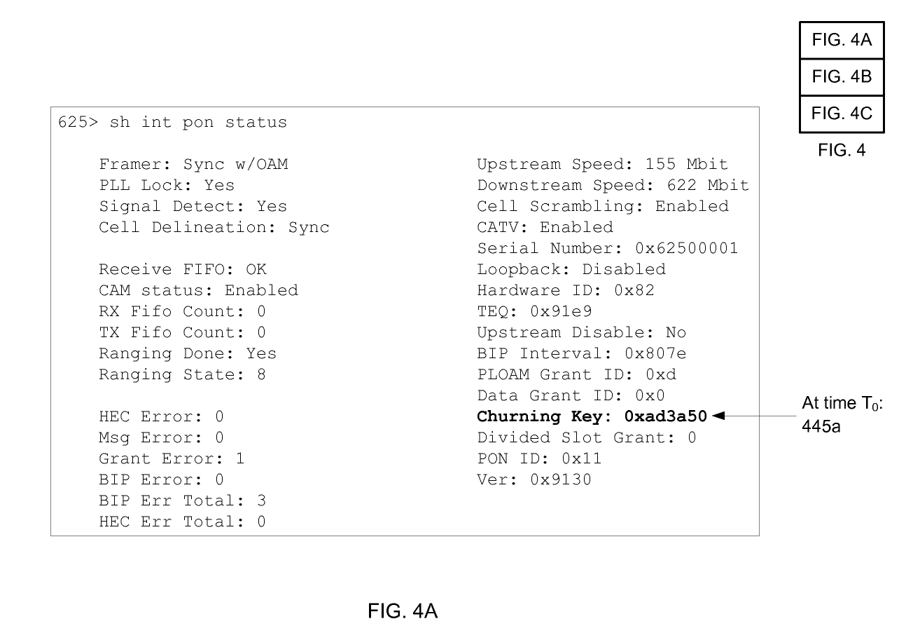

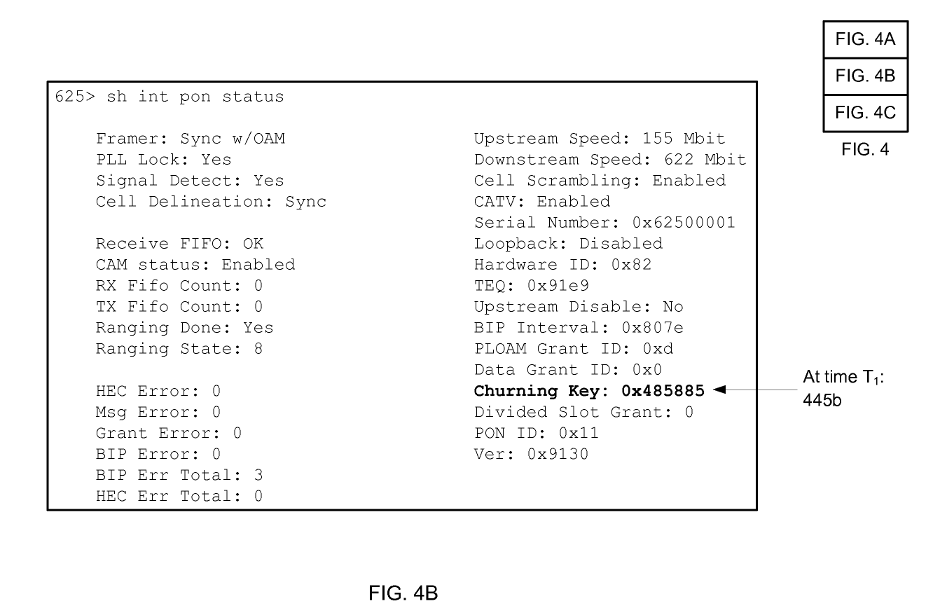

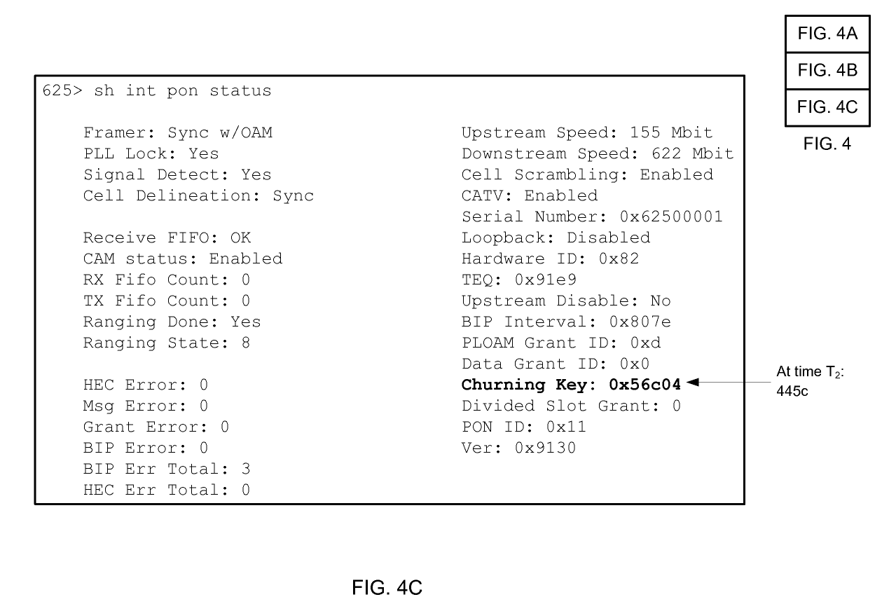

FIG. 4 is a sequence of printouts providing the status of an ONT. Each printout taken at a different time (T₀, T₁, and T₂) and providing a different randomly generated churning key 445a, 445b, and 445c, generally 445a-c of an ONT. Recall, the churning key 445a-c normally used to maintain a security state of downstream cells from an optical line terminal (OLT) to an optical network terminal (ONT). In contrast to the normal use of the churning key 445a-c, one embodiment incorporates a portion of the churning key 445a-c into a message of the protocol under test to produce the mutated message. In further contrast to the normal use of the churning key 445a-c, another embodiment incorporates a repetition of the churning key 445a-c into a message of a protocol under test to produce a mutated message.

A convenient embodiment of the present invention incorporates features for testing protocols into a fiber to the premises Optical Network Terminal (ONT), referred to hereinafter as an “ONT fuzzer.” The ONT fuzzer provides a protocol vulnerability test suite that covers protocol vulnerability testing for at least the following applications:

1) protocol testing on network devices connected to a Optical Line Termination (OLT) uplink providing such services as DHCP service, PPPoE service, IPoE service, and IP/MPLS routing;

2) protocol testing on application devices connected to the OLT uplink, such as a SIP Session Border Controller, SoftSwitch, SIP Configuration Server, IPTV Middleware, and Video Encoder; and

3) protocol testing on devices connected to a customer premises, such as a Broadband Home Router, VDSL Modem, SIP Phone, and SIP ATA.

In this embodiment, the ONT fuzzer produces mutated but valid messages on targets of devices external from an access network while the ONT fuzzer is in service. The ONT fuzzer generates such messages both locally on an Ethernet port of the ONT fuzzer and via a PON link against devices on the data uplink (i.e., devices in the service networks). To test some protocols, in particular connection-orientated or based protocols, the ONT fuzzer expects an acknowledgement or response message from the target before continuing with a test. In some instances, the foregoing may be accomplished in software, requiring no further modification to the hardware of a typical ONT.

During a test, the ONT fuzzer is ranged up with the OLT. The ONT fuzzer then establishes connectivity to one or more service networks. In one instance, the ONT fuzzer connects to all devices in the service networks, and, thus, tests all the devices in the service networks.

Because the ONT fuzzer is a network layer device of the OSI Reference Model (i.e., layer 3) that also handles messages of upper layer protocols (i.e., layers 4-7), this embodiment also tests upper layer protocols.

Embodiments of the present invention test or otherwise perform an attack on a protocol under test by incorporating a mutation into a message of the protocol under test as a function of a key normally used to maintain a security state between nodes in an access network to produce a mutated message. In one embodiment, the message into which the mutation is incorporated is provided as a file stored in flash memory. Each file stored represents a protocol under test. As an example of protocol under test, for the session initiated protocol (SIP), the file stored contains the following messages into which a mutation is incorporated to produce a mutated message:

REGISTER sip:<phone>@<IP Address>:<port>;transport=udp:user=phone;

INVITE sip:<phone>@<IP Address>:<port>;transport=udp user=phone;

ACK sip:<phone>@<IP Address>:<port>;transport=udp:user=phone;

CANCEL sip:<phone>@<IP Address>:<port>;transport=udp:user=phone;

BYE sip:<phone>@<IP Address>:<port>;transport=udp:user=phone; and

OPTIONS sip:<phone>@<IP Address>:<port>;transport=udp:user=phone

Alternatively, the message into which the mutation is incorporated may be based on an existing message communicated between a customer premises and a service network via an access network, for example, a response message to a request message.

One embodiment bases the message into which the mutation is incorporated by identifying a protocol under test from the existing message communicated between the customer premises and the service network via the access network. From the protocol under test identified, the embodiment selects a message into which the mutation is incorporated to produce the mutated message.

Another embodiment bases the message into which the mutation is incorporated by identifying a device from the existing message communicated between the customer premises and the service network via the access network. From the device identified, the embodiment selects a protocol under test, and, in turn, from the protocol under test selected, selects a message into which a mutation is incorporated to produce the mutated message.

Continuing with the example, a typical decoded INVITE message has the following format:

INVITE sip:7035551212@192.168.67.87:5060;transport=udp:user=phone.

In the foregoing example, to initiate an attack, a command is issued via a command line interface (CLI). An example command syntax is as follows: ATTACK <IP Address of Target> <Port> <Protocol> <Iteration>, where the bracketed text indicates arguments specified or otherwise supplied by a user (i.e., user input) or by a machine (e.g., a script). Issuing a command via a CLI is but one example of initiating testing a protocol in accordance with embodiments of the present invention. One skilled in the art will readily recognize that embodiments of the present invention contemplate other ways of initiating testing protocols. For example, the testing protocols in accordance with embodiments of the present invention may be initiated via a graphic user interface (GUI) or by using a script. As another example, testing protocols in accordance with embodiments of the present invention may be initiated responsively to a change in a service network or a customer premises accessed via an access network, such as adding a network node to the service network or the customer premises.

Continuing with the example, the <IP address> argument specifies a device under test at the network layer of the Open Systems Interconnection Basic Reference Model (OSI Reference Model), i.e., layer 3; the <port> argument specifies an application at the transport layer of the OSI Reference Model, i.e., layer 4; the <protocol> argument specifies a protocol under test; and the <iteration> argument specifies a number of times a test or attack of the protocol under test is conducted.

The foregoing is but one example of a command syntax. There may be more or less argument depending on any number of factors related to testing a protocol under test. For example, there may be an additional <wait time> argument specifying a pause between iterations. As another example, the <port> argument (an identified at layer 4) is not needed if testing a layer 3 protocol, such as Internetwork Protocol (IP).

Continuing with the example, the following command is issued:

ATTACK 192.168.67.87 5060 SIP 200.

Given the command issued specifying, among other things, SIP as the protocol under test, the following is an example message of the protocol under test:

REGISTER sip :<phone>@192.168.67.87:5060;transport=udp:user=phone,

where the bracketed text indicates a field of the example SIP REGISTER message in which a mutation is to be incorporated or otherwise mutated.

As discussed above, a message of a protocol under test may be provided in a file stored in flash memory. In one example, such a file is read and fields of a message of a protocol under test are replaced in a corresponding manner with arguments of a command issued, resulting in a message in which to incorporate a mutation.

Independent of a process resulting in a message in which to incorporate a mutation, given the foregoing SIP REGISTER message, an embodiment of the present invention incorporates a mutation, in this example, a churning key to produce the following example mutated message:

REGISTER sip: 50fdc9@192.168.67.87:5060;transport=udp:user=phone,

where the underlined text indicates the mutation incorporated to produce the mutated SIP REGISTER message.

Another embodiment incorporates a portion of the churning key to produce the following example mutated messages:

REGISTER sip:5@192.168.67.87:5060;transport=udp:user=phone;

REGISTER sip:50@192.168.67.87:5060;transport=udp:user=phone;

REGISTER sip:50f@192.168.67.87:5060;transport=udp:user=phone;

REGISTER sip:50fd@192.168.67.87:5060;transport=udp:user=phone; and

REGISTER sip:50fdc@192.168.67.87:5060;transport=udp:user=phone,

where the underlined text indicates the portion of the mutation incorporated to produce the mutated SIP REGISTER messages.

Yet another embodiment incorporates a repetition of the churning key to produce the following example mutated message:

REGISTER sip:50fdc950fdc950fdc950fdc9@192.168.67.87:5060;transport=udp:user=phone;

where the underlined text indicates the repetition of the mutation incorporated to produce the mutated SIP REGISTER message.

Continuing with the example, the embodiment transmits the mutated SIP REGISTER message from an access network to a network external from the access network and that is accessed via the access network to test SIP. In this example, the embodiment continues testing SIP for 200 times as specified in the command issued.

The embodiment tests SIP each of the 200 times by incorporating a different churning key into the SIP REGISTER message to produce an other mutated SIP REGISTER message and transmitting the other mutated SIP REGISTER message from the access network to the network external from the access network to test SIP.

TABLE 1

| No. | Time | Source | Destination | Protocol | Info |
|---|---|---|---|---|---|
| 1 | 10:48.8 | 192.168.0.180 | 172.10.2.13 | SIP/SDP | Request:INVITEsip:noone@sip.no.invalid, with session description |
| 2 | 10:50.8 | 192.168.0.180 | 172.10.2.13 | SIP/SDP | Request:INVITEaaaaa:noone@sip.no.invalid, with session description |
| 3 | 10:52.8 | 192.168.0.180 | 172.10.2.13 | SIP/SDP | Request:INVITEaaaaaaaaaaaaaaaa:noone@sip.no.invalid, with |
| | | | | | session description |
| 4 | 10:54.8 | 192.168.0.180 | 172.10.2.13 | SIP/SDP | Request:INVITEaaaaaaaaaaaaaaaaaaaaaaaaaaaaaaaa:noone@sip.no.invalid, |
| | | | | | with session description |
| 5 | 10:56.8 | 192.168.0.180 | 172.10.2.13 | SIP/SDP | Request:INVITEaaaaaaaaaaaaaaaaaaaaaaaaaaaaaaaaaaaaaaaaaaaaaaaaaaaaaaaa |
| 6 | 10:58.8 | 192.168.0.180 | 172.10.2.13 | SIP/SDP | Request:INVITEaaaaaaaaaaaaaaaaaaaaaaaaaaaaaaaaaaaaaaaaaaaaaaaaaaaaaaaa |
| 7 | 11:00.8 | 192.168.0.180 | 172.10.2.13 | SIP/SDP | Request:INVITEaaaaaaaaaaaaaaaaaaaaaaaaaaaaaaaaaaaaaaaaaaaaaaaaaaaaaaaa |
| 8 | 11:12.9 | 192.168.0.180 | 172.10.2.13 | SIP/SDP | Request:INVITE%s%s%s%s%s:noone@sip.no.invalid, with session |
| | | | | | description |
| 9 | 11:14.9 | 192.168.0.180 | 172.10.2.13 | SIP/SDP | Request:INVITE%s%s%s%s%s%s%s%s%s%s%s%s%s%s%s%s%s%s%s%s%s%s%s%s%s%s%s%s |
| 10 | 11:16.9 | 192.168.0.180 | 172.10.2.13 | SIP/SDP | Request:INVITE%s%s%s%s%s%s%s%s%s%s%s%s%s%s%s%s%s%s%s%s%s%s%s%s%s%s%s%s |
| 11 | 11:24.9 | 192.168.0.180 | 172.10.2.13 | SIP/SDP | Request:INVITE%.99d:noone@sip.no.invalid, with session |
| | | | | | description |
| 12 | 11:26.9 | 192.168.0.180 | 172.10.2.13 | SIP/SDP | Request:INVITE%.999d:noone@sip.no.invalid, with session |
| | | | | | description |
| 13 | 11:28.9 | 192.168.0.180 | 172.10.2.13 | SIP/SDP | Request:INVITE%s%s:noone@sip.no.invalid, with session |
| | | | | | description |
| 14 | 11:30.9 | 192.168.0.180 | 172.10.2.13 | SIP/SDP | Request:INVITE%.999d%.999d%.999d%.999d%.999d:noone@sip.no.invalid, |
| | | | | | with session description |
| 15 | 11:32.9 | 192.168.0.180 | 172.10.2.13 | SIP/SDP | Request:INVITE%.999d%.999d%.999d%.999d%.999d%.999d%.999d%.999d%.999d%. |
| 16 | 11:36.9 | 192.168.0.180 | 172.10.2.13 | SIP/SDP | Request:INVITEsip:::::sip.no.invalid, with session description |
| 17 | 11:38.9 | 192.168.0.180 | 172.10.2.13 | SIP/SDP | Request:INVITEsip::::::::::::::::sip.no.invalid, with session description |
| 18 | 11:40.9 | 192.168.0.180 | 172.10.2.13 | SIP/SDP | Request:INVITEsip::::::::::::::::::::::::::::::::sip.no.invalid, with session |
| | | | | | description |
| 19 | 11:43.0 | 192.168.0.180 | 172.10.2.13 | SIP/SDP | Request:INVITEsip::::::::::::::::::::::::::::::::::::::::::::::::::::: |
| 20 | 11:45.0 | 192.168.0.180 | 172.10.2.13 | SIP/SDP | Request:INVITEsip::::::::::::::::::::::::::::::::::::::::::::::::::::: |
| 21 | 11:47.0 | 192.168.0.180 | 172.10.2.13 | SIP/SDP | Request:INVITEsip::::::::::::::::::::::::::::::::::::::::::::::::::::: |
| 22 | 11:59.0 | 192.168.0.180 | 172.10.2.13 | SIP/SDP | Request:INVITEsip:sip.no.invalid, with session description |
| 23 | 12:03.0 | 192.168.0.180 | 172.10.2.13 | SIP/SDP | Request:INVITEsip:@sip.no.invalid, with session description |
| 24 | 12:05.0 | 192.168.0.180 | 172.10.2.13 | SIP/SDP | Request:INVITEsip:aaaaaaaaaaaaaaaa@sip.no.invalid, with session |
| | | | | | description |
| 25 | 12:07.0 | 192.168.0.180 | 172.10.2.13 | SIP/SDP | Request:INVITEsip:aaaaaaaaaaaaaaaaaaaaaaaaaaaaaaaa@sip.no.invalid, |
| | | | | | with session description |
| 26 | 12:09.0 | 192.168.0.180 | 172.10.2.13 | SIP/SDP | Request:INVITEsip:aaaaaaaaaaaaaaaaaaaaaaaaaaaaaaaaaaaaaaaaaaaaaaaaaaaa |
| 27 | 12:13.1 | 192.168.0.180 | 172.10.2.13 | SIP/SDP | Request:INVITEsip:noonesip.no.invalid, with session description |
| 28 | 12:15.1 | 192.168.0.180 | 172.10.2.13 | SIP/SDP | Request:INVITEsip:noone@@@@@@@@@@@@@@@@sip.no.invalid, |
| | | | | | with session description |
| 29 | 12:17.1 | 192.168.0.180 | 172.10.2.13 | SIP/SDP | Request:INVITEsip:noone@@@@@@@@@@@@@@@@@@@@@@@@@@@@@@@@sip.no.invalid, |
| 30 | 12:19.1 | 192.168.0.180 | 172.10.2.13 | SIP/SDP | Request:INVITEsip:noone@@@@@@@@@@@@@@@@@@@@@@@@@@@@@@@@@@@@@@@@@@@@@@@ |
| 31 | 12:23.1 | 192.168.0.180 | 172.10.2.13 | SIP/SDP | Request:INVITEsip:noone@a.a.a.a.dom, with session description |
| 32 | 12:25.1 | 192.168.0.180 | 172.10.2.13 | SIP/SDP | Request:INVITEsip:noone@a.a.a.a.a.a.a.a.a.a.a.a.a.a.a.a.a.a.a.a.a.a.a. |
| 33 | 12:27.1 | 192.168.0.180 | 172.10.2.13 | SIP/SDP | Request:INVITEsip:noone@a.a.a.a.a.a.a.a.a.a.a.a.a.a.a.a.a.a.a.a.a.a.a. |

Table 1 is an example of how valid SIP messages may be mutated to test SIP. Further mutation may involve modifying the port number, mismatching message types, and elongating the optional fields inside SIP messages. The same or similar procedure applies to all other protocols.

One embodiment in addition to the foregoing reports an effect of a mutated message transmitted on a protocol under test. In some instances, the effect reported indicates security and vulnerability of the protocol under test. When testing a protocol under test with a mutated message, as described above, in some cases a device or system under test will respond with a response message. By expecting a response message from the device or system under test before continuing, performance may be monitored. Further, by expecting such a response message before sending another mutated message, it is possible to monitor and validate whether the device or system under test sustained the attack or testing. For example, if the device or system under test does not respond in time (e.g., as defined by a protocol standard), the test fails and the user is notified. By doing so, an embodiment of the present invention monitors the performance of the device or system under test in near real time.

As an example, a convenient embodiment incorporates a mutation into a SIP INVITE message to produce a mutated SIP INVITE message. The embodiment transmits the mutated SIP INVITE message from an access network to a network external from the access network and accessed via the access network to test SIP. The embodiment expects a SIP 200 OK Status Response message. The embodiment stops testing and reports an error status (i.e., the effect of the mutated SIP INVITE message transmitted on SIP) to a tester, if the SIP 200 OK Status Response message is not as expected (e.g., not received).

For simplicity reasons, the protocol under test mentioned in this disclosure discusses only SIP. However, protocol coverage for embodiments of the present invention is not limited to SIP. Because example embodiments test a protocol under test by transmitting a mutated message from an access network to a network external from the access network and accessed via the access network, such as a service network and a customer premises, protocols running on devices residing in these networks may be tested as well.

One embodiment identifies a device from an existing message communicated between a customer premises and a service network via an access network. The device may be identified by a Media Access Control (MAC) address or other hardware address. The embodiment selects a protocol under test based on the device identified. The embodiment selects a message of the protocol under test selected into which the mutation is incorporated to produce the mutated message.

TABLE 2

| Devices under attack | Types of attacks |
|---|---|
| SIP SoftSwitch (Nortel CS2K, | SIP, RTSP, TLS, RTP, RTCP, |
| MetaSwitch, Coppercom, BroadSoft, | SRTP, ARP, RTP |
| NetCentrix) | |
| SIP Session Border Controller | SIP, RTSP, TLS, RTP, RTCP, |
| (Nextone, Acme Packets) | SRTP, ARP, RTP |
| Service Edge Router (Juniper ERX, | DHCP, IPv4, TCP, UDP, |
| Tellabs 8800, Redback) | IGMP, DNS, FTP, HTTP, |
| | OSPF, RSVP, BGP4, RIP, |
| | IS-IS, ARP, MPLS |
| SIP Configuration Server (Tellabs | IGMP, DNS, FTP, WGET, ARP |
| tConfig, Verizon iConfig) | |
| DHCP Server, DNS Server | IGMP, DNS, DHCP, ARP, FTP |
| Broadband Home Router - CPE Side | ACL, IGMP, DNS, DHCP, |
| (DLink, Actiontec, Westell) | ARP, FTP |
| SIP Phone, ATA - CPE Side | SIP, RTSP, TLS, RTP, RTCP, |
| (Cisco, Siptura, Avaya) | SRTP, ARP, RTP |

Table 2 lists example devices under test to be identified from an existing message communicated between a customer premises and a service network via an access network, and example protocols under test to be selected based on an identified device under test. Table 2 is not intended to be an exhaustive list of device under tests and protocol under tests. Table 2 is, however, intended to illustrate that a convenient embodiment bases a message into which a mutation is incorporated by identifying a device under test from the existing message communicated between the customer premises and the service network via the access network, and based on the device under test identified selects a protocol to test.

While described above in reference to testing a single protocol, one embodiment extracts information from an existing message communicated between a customer premises and a service network accessed via an access network. The embodiment, from the information extracted, self-initiates a message into which a mutation is incorporated to produce a mutated message. For example, extracting information from a message identifies or otherwise indicates that the message is of a first protocol. From the first protocol identified, the embodiment self initiates a message of a second protocol “related” to the first protocol.

Consider the following service scenario: from a customer premises, a user surfs the web by requesting a webpage served by a server from a service network. The service network is accessed via the access network. Surfing the web involves the DNS protocol (running on the user's computer and a DNS server) resolving a web address into an IP address of the server serving the webpage requested. Surfing the web further involves the HTTP protocol (running on the user's computer and a HTTP server) requesting and receiving the webpage requested. The DNS protocol and the HTTP protocol are “related” in the sense that a sequence of protocols is used to provide a service, namely, surfing the web.

To test the above surfing the web service scenario, the foregoing example embodiment tests DNS and HTTP together. As such, this embodiment extends testing a protocol to testing a sequence or suite of protocols to test a service, such as surfing the web. As another example, to test an IP telephony service, SIP (an application-layer control or signaling protocol) and RTP (an application-layer protocol for providing end-to-end network transport functions suitable for applications transmitting real-time data, such as audio and video) are tested together.

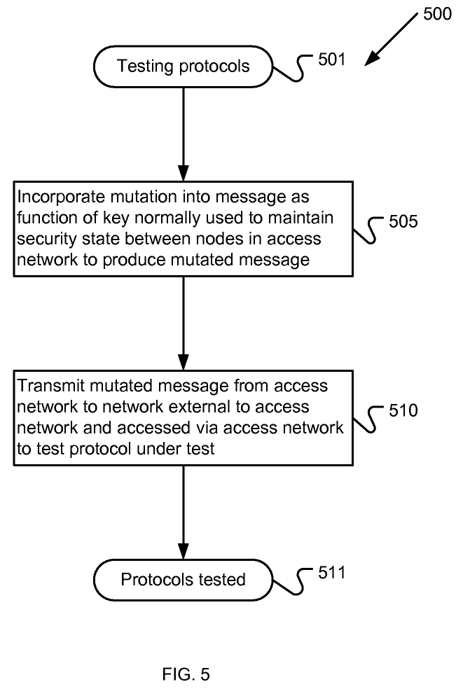

FIG. 5 illustrates an example process 500 for testing a protocol. The process 500 starts (501). The process 500 incorporates (505) a mutation into a message of a protocol under test as a function of a key normally used to maintain a security state between nodes in an access network to produce a mutated message. The process transmits (510) the mutated message from the access network to a network external from the access network and accessed via the access network to test the protocol under test. The process 500 ends (511) with the protocol tested.

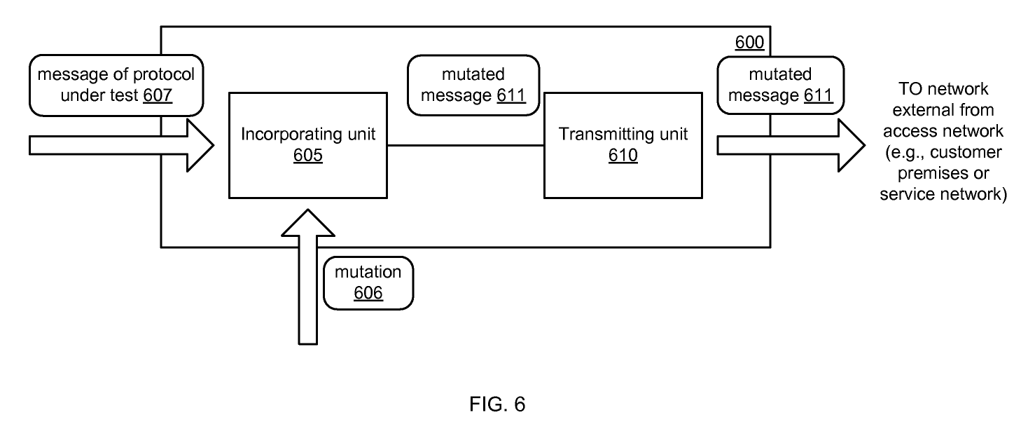

FIG. 6 illustrates an example apparatus 600 to test a protocol. The apparatus 600 includes an incorporating unit 605 and a transmitting unit 610 communicatively coupled to one another. The incorporating unit 605 incorporates a mutation 606 into a message 607 of a protocol under test as a function of a key (not shown) normally used to maintain a security state between nodes in an access network to produce a mutated message 611. The transmitting unit 610 transmits the mutated message 611 from the access network to a network external from the access network and accessed via the access network to test the protocol under test.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the invention.

It should be understood that elements of the block, flow, and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of computer readable medium, such as random access memory (RAM), read only memory (ROM), compact disk read only memory (CD-ROM), and so forth. In operation, a general purpose or application specific processor loads and executes the software in a manner well understood in the art.

While this invention has been particularly shown and described with references to example embodiments thereof, it will be understood by those skilled in the art that various changes in form and details may be made therein without departing from the scope of the invention encompassed by the appended claims.

The following is list of abbreviations used in this disclosure:

ACL Access Control List

ARP Address Resolution Protocol

BGPv4 Border Gateway Protocol version 4

CD-ROM Compact Disk Read Only Memory

CLI Command Line Interface

CPE Customer Premises Equipment

DHCP Dynamic Host Configuration Protocol

DNS Domain Name Server

FTP File Transfer Protocol

GUI Graphical User Interface

HTTP Hyper Text Markup Language

IGMP Internet Group Management Protocol

IP Internet Protocol

IP/MPLS Internet Protocol/Multi Protocol Label Switching

IPoE Internet Protocol over Ethernet

IPTV Internet Protocol Television

IPv4 Internet Protocol version 4

IS-IS Intermediate System to Intermediate System

LAN Local Area Network

MPLS Multi Protocol Label Switching

OLT Optical Line Terminal

ONT Optical Network Terminal

OSI Open System Interconnection

OSPF Open Shortest Path First

PON Passive Optical Network

PPPoE Point to Point Protocol over Ethernet

RAM Random Access Memory

RIP Routing Information Protocol

ROM Read Only Memory

RSVP Resource reSerVation Protocol

RTCP RTP Control Protocol

RTP Real-time Transport Protocol

RTSP Real Time Streaming Protocol

SIP Session Initiation Protocol

SIP ATA Session Initiation Protocol Analog Telephone Adapter

SIP/SDP Session Initiation Protocol/Session Description Protocol

SRTP Secure Real-time Transport Protocol

TCP Transfer Control Protocol

TDMA Time Division Multiple Access

TLS Transparent LAN Service

UDP User Datagram Protocol

VDSL Very High Speed Digital Subscriber Line

WGET WGET

What is claimed is:

1. A method for testing protocols, the method comprising:
incorporating a mutation into a message of a protocol under test as a function of a key normally used to maintain a security state between nodes in an access network to produce a mutated message; and
transmitting the mutated message from the access network to a network external from the access network and accessed via the access network to test the protocol under test.

2. The method of claim 1 wherein incorporating the mutation includes basing a message into which the mutation is incorporated on an existing message communicated between a customer premises and a service network via the access network to produce the mutated message.

3. The method of claim 2 wherein basing the message includes responding to request message communicated between the customer premises and the service network via the access network with a response message into which the mutation is incorporated to produce the mutated message.

4. The method of claim 2 wherein basing the message includes
extracting information from the existing message communicated between the customer premises and the service network via the access network; and
from the information extracted, self-initiating a message into which the mutation is incorporated to produce the mutated message.

5. The method of claim 2 wherein basing the message includes:
identifying a protocol under test from the existing message communicated between the customer premises and the service network via the access network; and
selecting a message of the protocol under test identified into which the mutation is incorporated to produce the mutated message.

6 The method of claim 2 wherein basing the message includes:
identifying a device from the existing message communicated between the customer premises and the service network via the access network;
selecting a protocol under test based on the device identified; and
selecting a message of the protocol under test selected into which the mutation is incorporated to produce the mutated message.

7. The method of claim 1 wherein incorporating the mutation includes in a passive optical network (PON), incorporating a portion of a churning key normally used to maintain a security state of downstream cells from an optical line terminal (OLT) to an optical network terminal (ONT) into the message of the protocol under test to produce the mutated message.

8. The method of claim 1 wherein incorporating the mutation includes in a passive optical network (PON), incorporating a repetition of a churning key normally used to maintain a security state of downstream cells from an optical line terminal (OLT) to an optical network terminal (ONT) into a message of a protocol under test to produce a mutated message.

9. The method of claim 1 wherein transmitting the mutated message includes transmitting the mutated message from the access network to a customer premises accessed via the access network to test the protocol under test.

10. The method of claim 1 wherein transmitting the mutated message includes transmitting the mutated message from the access network to a service network accessed access network to test the protocol under test.

11. The method of claim 1 further comprising reporting an effect of the mutated message transmitted on the protocol under test, the effect reported indicates security and vulnerability of the protocol under test.

12. An apparatus to test protocols, the apparatus comprising:
an incorporating unit to incorporate a mutation into a message of a protocol under test as a function of a key normally used to maintain a security state between nodes in an access network to produce a mutated message; and
a transmitting unit communicatively coupled to the incorporating unit to transmit the mutated message from the access network to a network external from the access network and accessed via the access network to test the protocol under test.

13. The apparatus of claim 12 wherein the incorporating unit includes a basing unit to base a message into which the mutation is incorporated on an existing message communicated between a customer premises and a service network via the access network to produce the mutated message.

14. The apparatus of claim 13 wherein the basing unit includes a responding unit to respond to the existing message communicated between the customer premises and the service network via the access network with a response message into which the mutation is incorporated to produce the mutated message.

15. The apparatus of claim 13 wherein the basing unit includes:
an extracting unit to extract information from the existing message communicated between the customer premises and the service network via the access network; and
a self-initiating unit communicatively coupled to the extracting unit to self-initiate a message into which the mutation is incorporated to produce the mutated message from the information extracted.

16. The apparatus of claim 13 wherein basing unit includes:
an identifying unit to identify a protocol under test from the existing message communicated between the customer premises and the service network via the access network; and
a selecting unit communicatively coupled to the identifying unit to select a message of the protocol under test identified into which the mutation is incorporated to produce the mutated message.

17. The apparatus of claim 13 wherein basing unit includes:
an identifying unit to identify a device from the existing message communicated between the customer premises and the service network via the access network;
a first selecting unit communicatively coupled to the identifying unit to select a protocol under test based on the device identified; and
a second selecting unit communicatively coupled to the first selecting unit to select a message of the protocol under test selected into which the mutation is incorporated to produce the mutated message.

18. The apparatus of claim 12 wherein the incorporating unit includes in a passive optical network (PON), an incorporating unit to incorporate a portion of a churning key normally used to maintain a security state of downstream cells from an optical line terminal (OLT) to an optical network terminal (ONT) into the message of the protocol under test to produce the mutated message.

19. The apparatus of claim 12 wherein the incorporating unit includes in a passive optical network (PON), an incorporating unit to incorporate a repetition of a churning key normally used to maintain a security state of downstream cells from an optical line terminal (OLT) to an optical network terminal (ONT) into a message of a protocol under test to produce a mutated message.

20. The apparatus of claim 12 wherein the transmitting unit includes a transmitting unit to transmit the mutated message from the access network to a customer premises accessed via the access network to test the protocol under test.

21. The apparatus of claim 12 wherein the transmitting unit includes a transmitting unit to transmit the mutated message from the access network to a service network accessed access network to test the protocol under test.

22. The apparatus of claim 12 further comprising a reporting unit to report an effect of the mutated message transmitted on the protocol under test, the effect reported indicates security and vulnerability of the protocol under test.

23. A computer program product including a computer readable medium having a computer readable program, the computer readable program, when executed by a computer causes the computer to:
incorporate a mutation into a message of a protocol under test as a function of a key normally used to maintain a security state between nodes in an access network to produce a mutated message; and
transmit the mutated message from the access network to a network external from the access network and accessed via the access network to test the protocol under test.
